(19) United States
(12) Patent Application Publication
(10) Pub. No.: US 2004/0244491 A1
(43) Pub. Date: Dec. 9, 2004

(54) Apparatus and method for ultrasonic inspection

(76) Inventors: Kamal M. Vyas, Springboro, OH (US); Venkatasubramanian Ananthanarayanan, Beavercreek, OH (US); Dharmendra M. Ramachandra, Centerville, OH (US)

Correspondence Address: Scott A. McBain, Delphi Technologies, Inc., Legal Staff-M/C 480-410-202, P.O. Box 5052, Troy, MI, 48007, US

(21) Appl. No.: 10/455,576

(22) Filed: Jun. 5, 2003

(51) Int. Cl. G01N 29/00

(52) U.S. Cl. 73/627

(57) ABSTRACT

A method and apparatus for testing specimens by means of ultrasonic waves. A fixture adapted to hold a test specimen is placed in a fluid reservoir. At least one test probe adapted to emit and receive ultrasonic waves is positioned in proximity to the test specimen, which is mounted to the test fixture. The test probe and/or the test specimen may be adapted to rotate and translate in relation to each other in a predetermined fashion during testing, subjecting a greater portion of the test specimen to the ultrasonic test signals for more complete coverage of the test specimen.

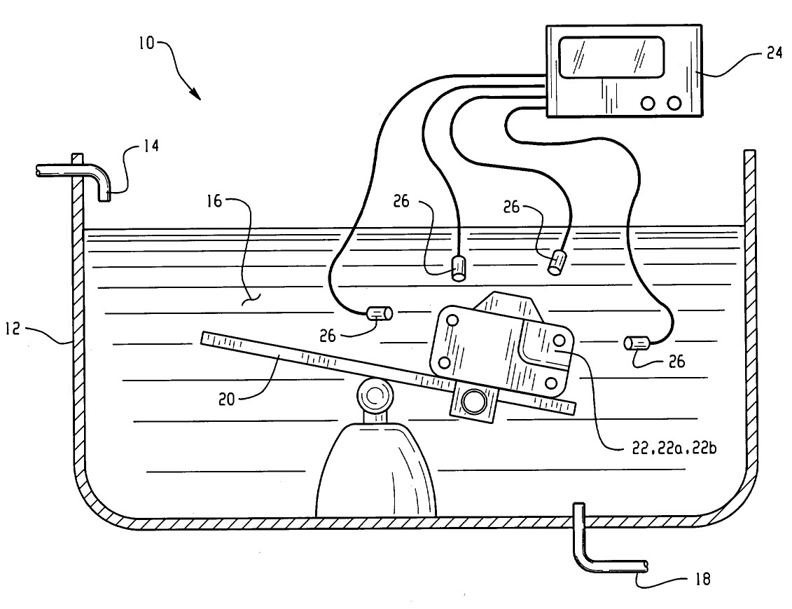

### TECHNICAL FIELD

The present invention pertains generally to an apparatus and method using ultrasonic waves for testing the integrity of specimens and, more particularly, an apparatus and method for reliably detecting flaws in parts having complex geometries.

### BACKGROUND OF THE INVENTION

When manufacturing parts, such as castings, it is desirable to inspect each part for flaws. A well-known inspection method is dye-penetrant testing, wherein the surfaces of the parts to be tested are coated with a visually perceptible penetrating material. The material is then removed and a developing agent is applied to the part, drawing any penetrant trapped in surface depressions or voids to the surface and highlighting such defects. Part inspection can be a costly and time-consuming process, particularly for parts having complex shapes and parts manufactured in high volume. Cost and time can be saved by sampling only a portion of each production lot. However, this inspection method may not be acceptable for certain types of parts, such as those that require expensive processing or are critical for the proper operation of a finished product. Further, some defects may go undetected until the part is stressed in its service environment. For example, a vehicle brake master cylinder is normally subjected to high fluid pressures. Undetected porosity clusters in the cast parts for the master cylinder may later open up under pressure, causing leaks.

Ultrasonic test methods overcome many of the deficiencies of other test methods. A first method, known as ultrasonic resonance spectroscopy (“URS”), involves the use of a test probe, such as a piezoelectric transducer, excited by a variable-frequency ultrasonic signal. The probe is placed in proximity to a known-good part and a characteristic resonance pattern, or “signature” is obtained which can be used as a reference. Parts of unknown quality are similarly tested and their signatures are compared to the reference. Differences in signatures between the tested parts and the reference are then used to detect flaws in the parts. However, URS is in general a pass/fail test and does not provide specific information on where the fault is located or the type of fault.

A second method of ultrasonic testing is “pulse-echo.” With pulse-echo testing a test probe is mounted in proximity to the part to be tested. An ultrasonic transmitter/receiver is used to transmit and receive ultrasonic energy via test probes. The transmitted ultrasonic waves are reflected differently by the test part in areas where discontinuities, layers, voids, or inclusions are present. The reflected waves are received by the test probe, sent to a receiver, and converted into an electrical signal for display on a video monitor. The display can show the relative thickness of the material, the location of defects, and the depth into the material where the defects are located.

A third method of ultrasonic testing is called “through-transmission.” In the through-transmission method, a first test probe emits ultrasonic energy on a first side of the material while a second test probe is placed on the opposite side to detect the ultrasonic signal. Scanning of the material using this method will result in the location of defects, flaws, and inclusions in the X-Y plane. This method is often used for nondestructive testing of multi-layered and multi-component materials.

A fourth method of ultrasonic testing is called “pitch-catch.” With this method the ultrasonic energy is transmitted at any angle to the surface of the material and received as reflected energy returning at the reflected angle, and is used primarily for cylindrical tubes and other nonlinear parallel sided surfaces. The pitch-catch method can determine depths of the flaw in the material as well as detect the location in the X-Y plane through scanning.

A disadvantage of all of these ultrasonic test methods is that the tests may not reliably find defects in every portion of a part, especially if the part has complex shapes. In particular, small cracks, cold shuts and porous areas are difficult to detect, partly because the coverage of the ultrasonic signal is necessarily closely focused to derive a response signal with a signal-to-noise ratio that is adequate to obtain test results. Consequently, parts that pass ultrasonic testing may still fail prematurely when placed into service. There is a need for an ultrasonic apparatus and method that can more reliably detect flaws in parts having complex shapes.

### SUMMARY OF THE INVENTION

The present invention is an apparatus and method for nondestructive ultrasonic testing of parts having complex shapes. In a first embodiment of the present invention, a fixture adapted to hold a test specimen is placed in a fluid reservoir. A plurality of test probes or a single probe adapted to emit and receive ultrasonic waves are positioned in proximity to the test specimen, which is mounted to the test fixture. The test probes and/or the test specimen may be adapted to rotate and translate in relation to each other. The test probes are constructed of material capable of transmitting and receiving ultrasound waves. The specimen and/or probes are rotated and translated in a predetermined fashion in relation to each other during testing to subject a greater portion of the part to the ultrasonic test signals for more complete coverage of the test specimen.

In a second embodiment of the present invention, a fluid medium is used to improve coupling between the test probes and the test specimen, improving the signal-to-noise ratio of the reflected signal for more resolution in the test results.

In a third embodiment of the present invention, some of the test probes may be particularly directed toward portions of the part where flaws are commonly found.

In a first method according to the present invention, a fixture is adapted to hold a test specimen. The fixture is placed in a fluid-containing reservoir. A first test specimen having known characteristics is installed onto the fixture. A plurality of test probes are placed in proximity to the first test specimen. The reservoir is then filled with a suitable fluid medium such that the fluid is interposed between the first test specimen and the test probes. An ultrasonic probe is used to direct ultrasonic waves at the first test specimen while periodically changing the positions of the test probes and the first test specimen in relation to each other in a predetermined fashion. The ultrasonic waves reflected from the first test specimen are received and characterized. The first test specimen is then removed and replaced with a second test specimen having unknown characteristics. The testing is repeated for the second test specimen. The reflected ultrasonic waves from the second test specimen are compared to the reflected ultrasonic waves for the first test specimen to determine if the second test specimen is acceptable.

### SUMMARY OF THE DRAWING

Further features of the present invention will become apparent to those skilled in the art to which the present embodiments relate from reading the following specification and claims with reference to the accompanying drawing, in which the drawing is a schematic diagram of an apparatus using ultrasonic waves to test parts according to several embodiments of the present invention.

### DESCRIPTION OF THE PREFERRED EMBODIMENTS

The drawing illustrates a schematic diagram of a test apparatus 10 in accordance with several embodiments of the present invention. A reservoir 12 includes an inlet 14 for filling the reservoir with a fluid medium 16 and an outlet 18 for draining the fluid. A fixture 20 capable of holding, rotating and translating a test specimen, such as a test specimen 22 is placed into reservoir 12. Rotation and translation may be accomplished by any suitable means, including but not limited to, pivots, swivels, joints, rotators, sockets, and ball mounts. It is to be understood in the following discussion that the numeral “22” represents the specimen generally, “22a” represents a known-good reference specimen, and “22b” represents a specimen of unknown quality. The specimen 22 may be, for example, a cast part.

An ultrasonic transmitter/receiver 24, which may be a single unit or a separate transmitter and receiver, is fitted with at least one test probe 26. A transmitter portion of transmitter/receiver 24 generates the electrical signals used by the test probes 26 to emit ultrasonic waves, while a receiver portion is used to monitor, record or display electrical signals corresponding to the ultrasound energy received by the test probes 26. The test probes 26 may be piezoelectric transducers adapted to emit or receive, or both emit and receive ultrasonic waves.

The test probes 26 are positioned at various predetermined locations in relation to test specimen 22. The test probes 26 may be adapted to rotate and translate in relation to the test specimen 22 by any suitable means, including, but not limited to, pivots, swivels, joints, rotators, sockets, and ball mounts. Some of the test probes 26 may be particularly directed towards portions of test specimen 22 where defects are commonly found. Testing of the test specimen 22 is performed by transmitting ultrasonic waves from transmitter/receiver 24 through test probes 26 and directing the ultrasonic waves toward the test specimen. Testing may be performed by URS, pulse-echo, through-transmission and pitch-catch test methods, the testing being accomplished by any one or a combination of these methods. Reflected ultrasonic waves are coupled to the test probes 26 and sent to the receiver portion of transmitter/receiver 24, where the reflected waves are analyzed.

Before performing tests on specimens 22b of unknown quality, a known-good test specimen, 22a, is first tested and characterized to serve as a reference or “standard.” After the known-good test specimen 22a has been characterized, test specimens 22b of unknown quality may be similarly tested. The reflected ultrasonic waves from the test specimens 22b are compared to the waves from the known-good test specimen 22a to determine the quality of the specimens 22b. Deviations in the characteristics of the reflected waves from the specimen 22b in comparison to the reference specimen may be interpreted as failures, if the deviations exceed a predetermined amount. Accordingly, the specimen 22b may be rejected.

In a first embodiment of the present invention, the test probes 26 may be fixed in a stationary position while fixture 20 is rotated and translated to predetermined positions in relation to the test probes 26, achieving greater coverage of the test specimen 22. The increased coverage provides more opportunities to detect flaws in the specimen 22 than is possible when the test probes and test specimen are kept in a stationary position in relation to each other. Alternatively, the test probes 26 may be rotated and translated to predetermined positions while the test specimen 22 is fixed in a stationary position.

In a second embodiment of the present invention, the reservoir 12 may be filled with a suitable fluid medium 16, such as water, to more efficiently conduct ultrasonic waves between the test probes 26 and the test specimen 22 to raise the signal-to-noise ratio of the reflected ultrasonic signal.

In a third embodiment of the present invention, the number and locations of the test probes 26 may be tailored to the shapes and geometries of known problem areas of specimen 22, as is within the level of skill of the artisan.

In a fourth embodiment of the present invention, the spectrum of ultrasonic frequencies produced and analyzed by the ultrasonic transmitter/receiver 24 may be tailored to detect particular faults. For example, the spectrum may be a relatively low range of frequencies to better detect small clusters of porous materials in a cast test specimen 22. Other tailoring techniques are left to the artisan.

In a fifth embodiment of the present invention, ultrasonic transmitter/receiver 24 may be computer-controlled. The characteristics of the test probes 26 may be controlled by means of a computer program designed to carry out ultrasonic testing using excitation tailored to the test specimen 22.

In a sixth embodiment of the present invention, ultrasonic testing may be accomplished by means of resonance, pulse-echo, through-transmission and pitch-catch ultrasonic testing, the testing being accomplished by any one or a combination of these methods.

In a seventh embodiment of the present invention, the installation and removal of the test specimen 22, the translation and rotation of the test probes 26 and/or fixture 20, analysis of the test results, and acceptance or rejection of the inspected specimen may be accomplished manually, or automatically as part of a production line.

In an eighth embodiment of the present invention, a single test probe 26 is adapted to emit and receive ultrasonic waves. The test probe 26 may be fixed in relation to the test specimen 22, or may be rotated and translated in relation to the test specimen. Alternatively, the test specimen 22 may be rotated and translated in relation to the single test probe 26.

In a first method according to the present invention, a fixture 20 is adapted to hold a test specimen 22. The fixture 20 is placed into a fluid reservoir 12. A first test specimen 22a having known characteristics is placed onto the fixture 20. A plurality of test probes 26 are arranged in proximity to the first test specimen 22a. The reservoir 12 is filled with a fluid medium such that the medium is interposed between the first test specimen 22a and the test probes 26. Ultrasonic waves are transmitted and directed at the first test specimen 22a by a transmitter/receiver 24, while periodically changing the position of the test probes 26 in relation to the test specimen in a predetermined fashion. The ultrasonic waves reflected by the test specimen 22a are received by transmitter/receiver 24 and are characterized. The first test specimen 22a is then removed and replaced with a second test specimen 22b having unknown characteristics. Ultrasonic waves are transmitted at the second test specimen 22b in a like manner as the first test specimen 22a. The transmitter/receiver 24 receives ultrasonic waves reflected from the second test specimen 22b. The reflected wave characteristics of the first and second test specimens 22a,22b are compared, and the second test specimen 22b is accepted or rejected, depending upon the nature and extent of dissimilarity between the characteristics of the first and second test specimens.

The various embodiments have been described in detail with respect to specific embodiments thereof, but it will be apparent that numerous variations and modifications are possible without departing from the spirit and scope of the embodiments as defined by the following claims.

1: An apparatus for testing the quality of test specimens by means of ultrasonic waves, comprising:
a) a reservoir for holding a fluid medium;
b) a fixture located within the reservoir, the fixture being adapted to hold a test specimen;
c) at least one test probe adapted to emit and receive ultrasonic waves, the test probe being positioned in proximity to the test specimen;
c) a means for rotating and translating the test specimen and test probe in relation to each other;
e) a transmitter and receiver adapted to transmit and receive ultrasonic waves, the transmitter and receiver being coupled to the test probe; and
f) a reference test specimen of known quality, wherein the reference test specimen provides information for comparison with test specimens of unknown quality in order to test the quality of the test specimens by means of ultrasonic waves.

2: The apparatus of claim 1, further comprising a fluid medium placed in the reservoir such that the fluid is completely interposed between the test specimen and the test probe.

3: The apparatus of claim 1 wherein the reservoir further comprises a fluid inlet and a fluid outlet.

4: The apparatus of claim 1 wherein the test probe is fixed and the test specimen is rotated and translated to a plurality of predetermined positions in relation to the test probe by movement of the fixture.

5: The apparatus of claim 1 wherein the test specimen is fixed and the test probe is rotated and translated to a plurality of predetermined positions in relation to the test specimen.

6: The apparatus of claim 1 wherein the frequency range of the transmitter and receiver are matched to predetermined features and flaws in a particular test specimen.

7: The apparatus of claim 1 wherein the number of test probes and their locations is tailored to predetermined and known problem areas of a particular test specimen.

8: The apparatus of claim 1 wherein the transmitter and receiver are computer controlled.

9: The apparatus of claim 1 wherein the transmitter and receiver are adapted to transmit and receive ultrasonic resonance spectroscopy signals.

10: The apparatus of claim 1 wherein the transmitter and receiver are adapted to transmit and receive ultrasonic pulse-echo signals.

11: The apparatus of claim 1 wherein the transmitter and receiver are adapted to transmit and receive ultrasonic through-transmission signals.

12: The apparatus of claim 1 wherein the transmitter and receiver are adapted to transmit and receive ultrasonic pitch-catch signals.

13: A method for inspecting test specimens by means of ultrasonic waves, comprising the steps of:
a) obtaining a reservoir for a fluid medium;
b) adapting a fixture to movably hold a test specimen;
c) placing the test fixture into the reservoir;
d) installing a first test specimen having known characteristics onto the fixture;
e) arranging at least one test probe in proximity to the first test specimen;
f) filling the reservoir with a fluid medium such that the medium is interposed between the first test specimen and the test probe;
g) connecting an ultrasonic transmitter and receiver to the test probe;
h) transmitting and directing ultrasonic waves at the first test specimen via the test probe, while periodically changing the position of the test probe in relation to the test specimen in a predetermined fashion;
i) receiving via the test probe ultrasonic waves reflected from the first test specimen and characterizing the ultrasonic waves reflected from the first test specimen;
j) removing the first test specimen from the fixture and installing a second test specimen having unknown characteristics;
k) transmitting ultrasonic waves at the second test specimen in a like manner as the first test specimen and receiving ultrasonic waves reflected from the second test specimen;
l) comparing the characterized reflected ultrasonic waves received from the first test specimen with the reflected ultrasonic waves received from the second test specimen; and
m) rejecting the second test specimen if the ultrasonic waves received from the second test specimen deviate from the characterized ultrasonic waves received from the first specimen in a predetermined manner.

14: The method of claim 13 wherein the steps of installing the first and second test specimens onto the test fixture and removing the first and second test specimens from the test fixture is performed manually.

15: The method of claim 13 wherein the steps of installing the first and second test specimens onto the test fixture and removing the first and second test specimens from the test fixture is performed automatically.

16: The method of claim 13 wherein the steps of transmitting and receiving ultrasonic waves is accomplished using resonance spectroscopy means for ultrasonic testing.

17: The method of claim 13 wherein the steps of transmitting and receiving ultrasonic waves is accomplished using pulse-echo means for ultrasonic testing.

18: The method of claim 13 wherein the steps of transmitting and receiving ultrasonic waves is accomplished using through-transmission means for ultrasonic testing.

19: The method of claim 13 wherein the steps of transmitting and receiving ultrasonic waves is accomplished using pitch-catch means for ultrasonic testing.

20: The method of claim 13 wherein the steps of transmitting and receiving ultrasonic waves further comprises the step of setting the frequency range of the transmitted ultrasonic waves to match predetermined features and flaws in the first and second test specimens and setting the frequency range of the receiver to the frequency range of the transmitted ultrasonic waves.

21: The method of claim 13 wherein the step of periodically changing the position of the test probe in relation to the test specimen is accomplished by fixing the first and second test specimens in place and moving the test probe to a plurality of positions.

22: The method of claim 13 wherein the step of periodically changing the position of the test probe in relation to the first and second test specimens is accomplished by fixing the test probe in place and moving the test specimen to a plurality of positions.

23: The method of claim 13 wherein the at least one test probe comprises a plurality of test probes, and further comprising the step of tailoring the number of test probes and the locations of the test probes to the shape and geometry of the first and second test specimens.

24: The method of claim 13, further comprising the step of controlling the transmitter and receiver with a computer.
